(19) United States
(12) Patent Application Publication
(10) Pub. No.: US 2021/0399595 A1
(43) Pub. Date: Dec. 23, 2021

(54) Electromagnetic Induction Device for Electric Power Generation

(71) Applicant: Richard Shao Wei CHIN, New Taipei (TW)

(72) Inventor: Chien-Chun Yu, New Taipei (TW)

(21) Appl. No.: 16/909,518

(22) Filed: Jun. 23, 2020

(51) Int. Cl. H02K 1/18; H02K 1/28; H01Q 1/26

(52) U.S. Cl. CPC H02K 1/18; H01Q 1/26; H02K 1/28

(57) ABSTRACT

A magnetic induction device includes a cylindered shell, a stator assembly having a plurality stator units fixed axially and equal spaced inside the cylindered shell, each stator unit including a stator base and a plurality of coils azimuthally arranged within the stator base with equal radical angle distribution, and a rotor assembly having a plurality of rotor units, each rotor unit including a rotor base and a plurality of permanent magnets azimuthally arranged inside the rotor base with equal radical angle distribution, wherein the plurality of rotor units are connected by a rotation shaft for rotating coherently and each rotor unit is arranged in between neighboring stator units.

### TECHNICAL FIELD

The present invention relates to an electric power generation equipment, and more particularly, an electromagnetic induction device for electric power generation.

### BACKGROUND

in electricity generation (electric power generation), an electric generator is a device that converts mechanical energy to electrical energy. A generator forces electric current to flow through an external circuit. The source of mechanical energy may be a reciprocating or turbine steam engine, water falling through a turbine or waterwheel, an internal combustion engine, a wind turbine, a hand crank, compressed air, or any other source of mechanical energy. In practical applications, generators provide nearly all of the power for electric power grids.

The reverse conversion of electrical energy into mechanical energy is done by an electric motor, and motors and generators have many similarities.

Electrical generators and motors (such as of the AC induction or DC variety) typically include an outer stator (or stationary component) which is usually shaped as a hollow cylinder containing copper wires which are wound or otherwise configured within the inner facing wall. In a motor configured application, electricity flowing into selected pairs of coils configured within the stator (a three phase motor typically includes three individual pairs of coils which are arranged in opposing and partially circumferentially offsetting fashion) results in rotation of an interiorly positioned rotor component.

The rotor is usually shaped as a solid cylinder that sits inside the stator (with a defined air gap between the outer cylindrical surface of the rotor and the inner cylindrical surface of the stator) with an output shaft extending from an axial centerline of the rotor. The rotor further includes a series of permanent magnets embedded within its outer surface.

Currently existing electrical motors or generators contain components with iron piece, such as lamented steel sheets or silicon steel sheets, used as coil winding core of a stator, magnetic field generating from these components can interact with permanent magnets of a rotor and can reduce power generating efficiency.

In this application, an electromagnetic induction device without lamented steel sheets for electric power generation is proposed. A power generator having high usage efficiency and no iron loss can be realized by utilizing copper wire only for coil winding with suitable coil stacking configuration in stator structure combining with permanent magnets assembled rotator.

### SUMMARY OF THE INVENTION

To achieve the above purpose, the present invention provides a magnetic induction device including a cylindered shell, a stator assembly having a plurality stator units fixed axially and equal spaced inside the cylindered shell, each stator unit including a stator base and a plurality of coils azimuthally arranged within the stator base with equal radical angle distribution; and a rotor assembly having a plurality of rotor units, each rotor unit including a rotor base and a plurality of permanent magnets azimuthally arranged inside the rotor base with equal radical angle distribution, wherein the plurality of rotor units are connected by a rotation shaft for rotating coherently and each rotor unit is arranged in between neighboring stator units.

In one preferred embodiment, the stator base is a cylindered shape having a center hole for passing the rotation shaft.

In one preferred embodiment, the stator base has a space formed between a circular inner wall and a circular outer wall for accommodating the coils.

In one preferred embodiment, the space formed between the circular inner wall and the circular outer wall of the stator base is equally partitioned into two subsections along the its axial direction.

In one preferred embodiment, each of the coils is winded by enamel-insulated conducting wire and forms a loop structure with bended “Z” shape cross section.

In one preferred embodiment, each of the coils can partially stack on top of each other side by side for forming compact packing.

In one preferred embodiment, the rotor unit includes a non-magnetic cylindered rotor base having a central hole for coupling the rotation shaft.

In one preferred embodiment, the magnetic poles of neighboring permanent magnets have opposite magnetic polarity arranged alternatively.

In one preferred embodiment, each of the permanent magnets is a columnar with equilateral triangular cross section and can be arranged to have their individual vertical bisector aligned with a set of radial axes of the rotor base with equal radical angle distribution.

In one preferred embodiment, the permanent magnets with a first type of the magnetic polarity can be configured to face toward the center of the rotor base while the base of the permanent magnets with a second type of the magnetic polarity can be configured to face toward the outer edge of the rotor base.

In one preferred embodiment, the permanent magnets with the first type of the magnetic polarity is N pole.

In one preferred embodiment, the permanent magnets with the second type of the magnetic polarity is S pole.

### BRIEF DESCRIPTION OF THE DRAWINGS

The components, characteristics and advantages of the present invention may be understood by the detailed descriptions of the preferred embodiments outlined in the specification and the drawings attached:

FIG. 1 illustrates a 3D view of an electromagnetic induction device for electric power generation according to a preferred embodiment of the present invention.

FIG. 2 illustrates a cross-sectional view of an electromagnetic induction device for electric power generation according to a preferred embodiment of the present invention.

FIG. 3(a) illustrates a front view of one of the stator units of an electromagnetic induction device according to a preferred embodiment of the present invention.

FIG. 3(b) illustrates a cross-sectional view of one of the stator units of an electromagnetic induction device along E-E cutting direction according to a preferred embodiment of the present invention.

FIG. 3(c) illustrates a cross-sectional view of the stator unit of an electromagnetic induction device along F-F cutting direction according to a preferred embodiment of the present invention.

FIG. 4(a) illustrates a front view of one of the rotor units of an electromagnetic induction device according to a preferred embodiment of the present invention.

FIG. 4(b) illustrates a cross-sectional view of one of the rotor units of an electromagnetic induction device according to a preferred embodiment of the present invention.

FIG. 5(a)-5(b) illustrate a three-phase coil winding configuration of one of the stator units of an electromagnetic induction device according to a preferred embodiment of the present invention.

FIG. 5(c) illustrates a cross-sectional view of configuration between stator units and rotor units of the magnetic induction device according to a preferred embodiment of the present invention.

FIG. 5(d) illustrates connection of the stator units having three-phase winding according to a preferred embodiment of the present invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

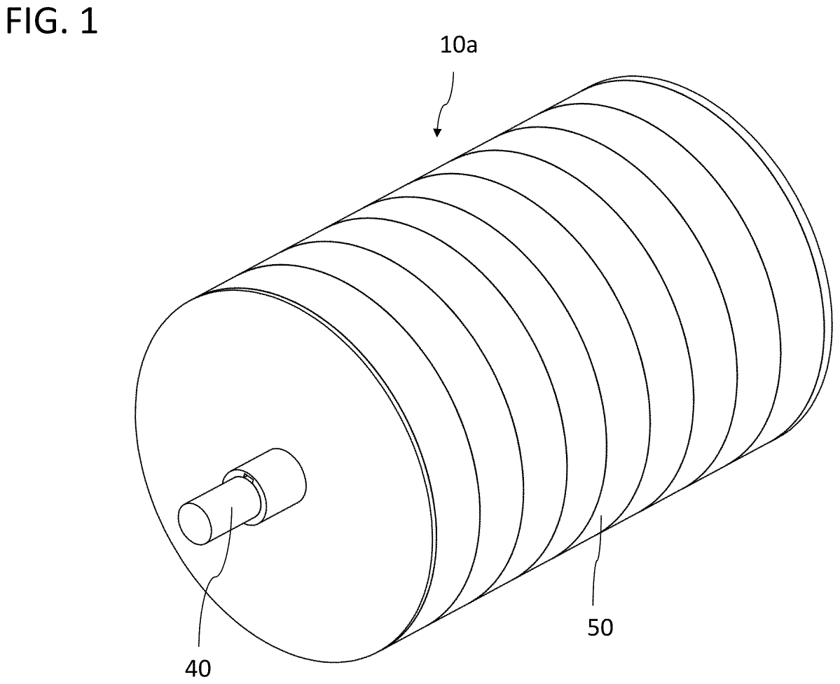

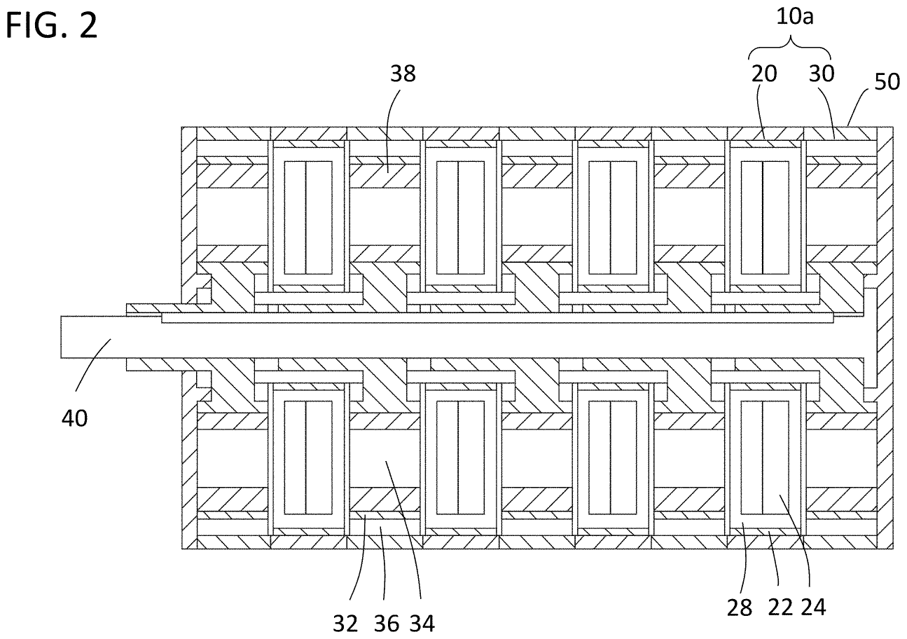

As depicted in FIG. 1 and FIG. 2, an electromagnetic induction device 10a for electric power generation or a power generator is disclosed. Power generator consists a plurality of coaxial assembled electromagnetic induction devices 10a installed inside a shell 50 with a cylinder shape, the electromagnetic induction device 10a includes a stator assembly containing a plurality of stator units 20 and a rotor assembly containing a plurality of rotor units 30. The plurality of stator units 20 are fixed axially and equal spaced inside the shell 50 acted as a stator, the plurality of rotor units 30 are connected by a rotation shaft 40 capable of rotating coherently. Inside the electromagnetic induction device 10a, each rotor unit 30 is installed in between two stator units 20.

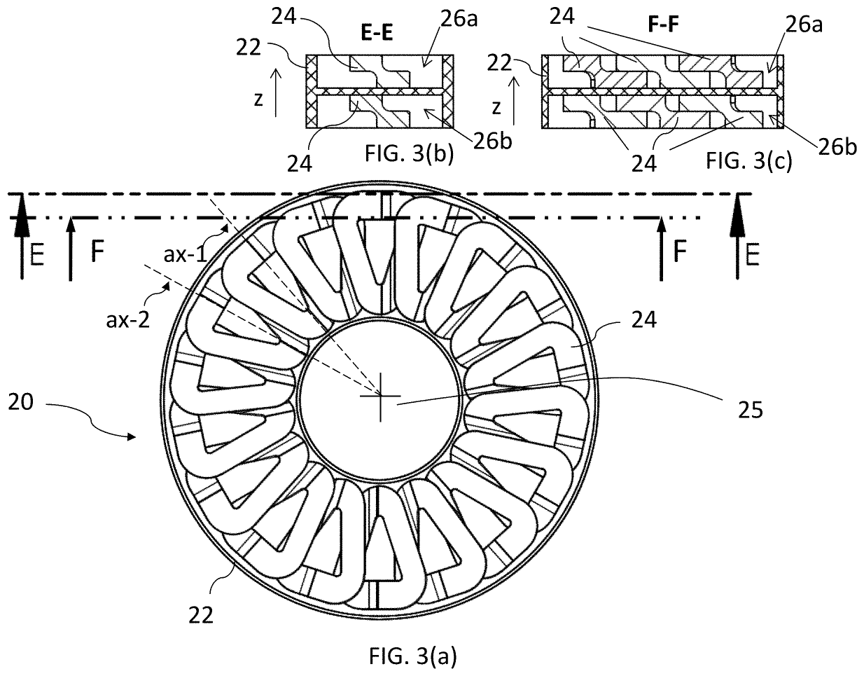

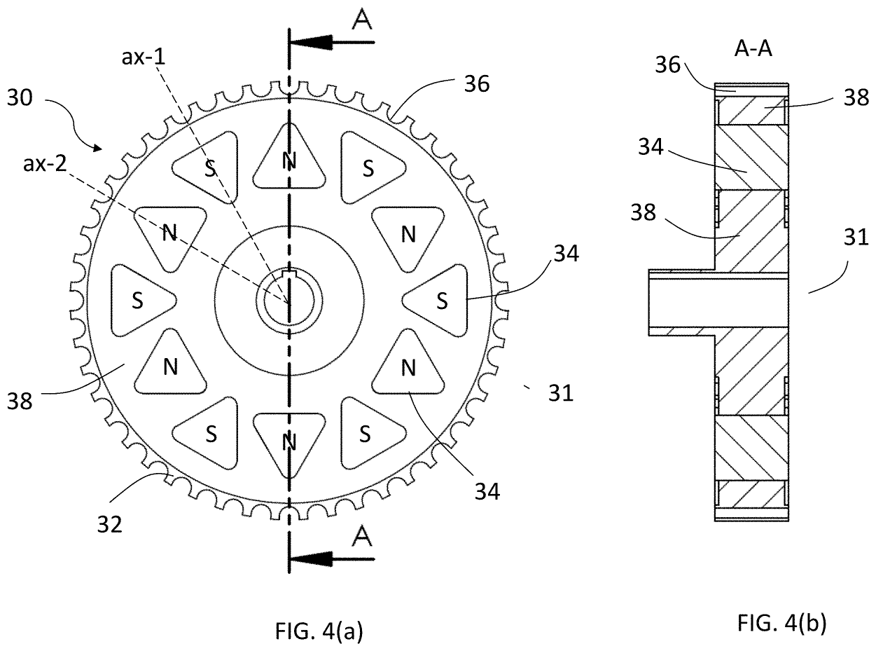

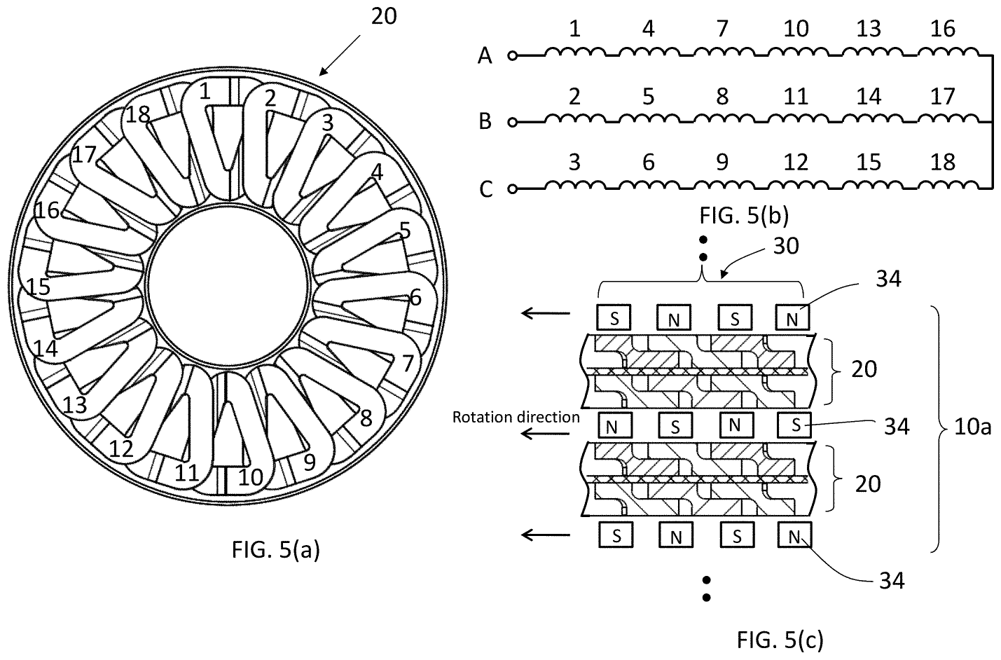

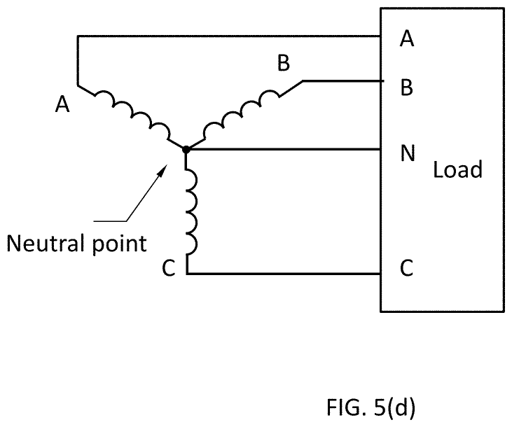

FIG. 3(a) illustrates a front view of a stator unit 20, which includes a non-magnetic stator base 22 and a plurality of coils 24 azimuthally arranged with equal radical angle distribution within the coil base 22. In one embodiment, the number of the coils 24 is ranged from 12-72, preferably, 18-36. Each of the coils 24 is winded by enamel-insulated copper wire (conducting wire) and forms a loop structure with bended “Z” shape cross section as shown in FIG. 3(b) (which is a cross-sectional view along E-E cutting direction and FIG. 3(c) (which is a cross-sectional view along F-F cutting direction). In this manner, please refers to FIG. 3(a)-3(c), each of the coils 24 forms bended cross section, which can be partially stacked on top of each other side by side with compact packing capability, where the coils 24 can be arranged to have their individual vertical bisector aligned with a set of radial axes (ax-1, ax-2, . . . ) of the stator base 22. The overlap area between adjacency coils is around 30-50 percent surface area of the coils. In one of the preferred embodiments, the number of windings of each coil is 100-140 turns, preferably, 120 turns. In one of the preferred embodiments, the stator base 22 is a cylinder shape having a center hole 25 for passing the rotation shaft 40 through and a space formed between a circular inner wall and a circular outer wall for accommodating coils 24 within, the space is equally partitioned into two subsections along the axial direction (z direction) with a partition wall in between. Coils installed inside both subsection of the stator base 22 can interact with permanent magnets of rotor unit (please refer to FIG. 1, FIG. 4, and FIG. 5) installed on both sides of the stator base 22. In one of the preferred embodiment, each of the coils 24 is wrapped with enamel-insulated conducting wire to form an isosceles triangular like shape (or similar shape, such as trapezoid shape) and then bended along its vertical bisector to form a “Z” shape cross section. Each of the isosceles triangular shape (or trapezoid shape) coils 24 is arranged with its base facing the circular outer wall of the stator base 22. Once these coils 24 have installed in their correct positions, a filler material 28, such as epoxy resin mixer, is filled with the space (26a, 26b) for securing coils in place and improving coil's insulating and thermal properties.

FIG. 4(a) illustrates a front view of an individual rotor unit 30, which includes a disk like (cylindered) non-magnetic rotor base 32 having a plurality of permanent magnets 34 (which can be NdFeB permanent magnets) installed, a central hole 31 for coupling a rotation shaft 40, and a plurality of slots 36 arranged at outer edge of the magnetic base for reducing weight and enhancing heat dissipation. These permanent magnets 34 are azimuthally arranged with equal radical angle distribution within the non-magnetic rotor base 32 and magnetic poles of neighboring magnets have opposite magnetic polarity, i.e. N pole versus S pole, arranged alternatively. FIG. 4(b) shows a cross-sectional view of an individual rotor unit 30 along A-A cutting direction. Once these permanent magnets 34 have installed in their correct positions, a filler material 38, such as epoxy resin mixer, is filled with the rest space for securing these permanent magnets in place. In one of the preferred embodiments, each of the permanent magnets 34 is a columnar with equilateral triangular cross section, where the permanent magnets 34 can be arranged to have their individual vertical bisector aligned with a set of radial axes (ax-1, ax-2, . . . ) of the magnet base 32 with equal radical angle distribution and the base of the permanent magnets 34 with a first type of the magnetic polarity (for example N pole) can be configured to face toward the center of the magnet base 32 while the base of the permanent magnets 34 with a second type of the magnetic polarity (for example S pole) can be configured to face toward the outer edge of the magnet base 32. In one of the preferred embodiments, each permanent magnet can produce a magnetic field of 3000-7000 Gauss, preferably, 5000 Gauss.

FIGS. 5(a)-5(b) show an exemplary winding configuration of one set of the stator unit 20, a connection of three-phase windings A, B, and C is illustrated in FIG. (b), where the marked numbers in FIG. 5(a) represent individual coil of the stator unit 20.

FIG. 5(c) illustrates a cross-sectional view of configuration between stator units 20 and rotor units 30 of the magnetic induction device 10a. From FIG. 5(c), it is clear that the compact packing stator units 20 together with the columnar permanent magnets 34 with equilateral triangular cross section installed in the rotor units 30 can provide a highly efficient magnetic induction unit without any lamented steel sheets needed for coil winding.

FIG. 5(d) illustrates connection of the rotor unit 20 having three-phase windings A, B, and C, where the AC power generated from the magnetic induction device 10a can be fed into the load for electric application.

As will be understood by persons skilled in the art, the foregoing preferred embodiment of the present invention illustrates the present invention rather than limiting the present invention. Having described the invention in connection with a preferred embodiment, modifications will be suggested to those skilled in the art. Thus, the invention is not to be limited to this embodiment, but rather the invention is intended to cover various modifications and similar arrangements included within the spirit and scope of the appended claims, the scope of which should be accorded the broadest interpretation, thereby encompassing all such modifications and similar structures. While the preferred embodiment of the invention has been illustrated and described, it will be appreciated that various changes can be made without departing from the spirit and scope of the invention.

What is claimed is:

1. A magnetic induction device comprising:
a cylindered shell;
a stator assembly having a plurality stator units fixed axially and equal spaced inside the cylindered shell, each stator unit including a stator base and a plurality of coils azimuthally arranged within the stator base with equal radical angle distribution; and
a rotor assembly having a plurality of rotor units, each rotor unit including a rotor base and a plurality of permanent magnets azimuthally arranged inside the rotor base with equal radical angle distribution, wherein the plurality of rotor units are connected by a rotation shaft for rotating coherently and each rotor unit is arranged in between neighboring stator units.

2. The magnetic induction device of claim 1, wherein the stator base is a cylindered shape having a center hole for passing the rotation shaft.

3. The magnetic induction device of claim 1, wherein the stator base has a space formed between a circular inner wall and a circular outer wall for accommodating the coils.

4. The magnetic induction device of claim 3, wherein the space formed between the circular inner wall and the circular outer wall of the stator base is equally partitioned into two subsections along the its axial direction.

5. The magnetic induction device of claim 3, wherein the coils installed inside both of the two subsections of the stator base.

6. The magnetic induction device of claim 1, wherein each of the coils is winded by enamel-insulated conducting wire and forms a loop structure with bended “Z” shape cross section.

7. The magnetic induction device of claim 6, wherein each of the coils can be partially stacked on top of each other side by side for forming compact packing, an overlap area between adjacency coils is 30-50 percent surface area of the coils.

8. The magnetic induction device of claim 1, wherein the stator base is non-magnetic.

9. The magnetic induction device of claim 1, wherein the rotor unit includes a non-magnetic cylindered rotor base having a central hole for coupling the rotation shaft.

10. The magnetic induction device of claim 1, wherein the magnetic poles of neighboring permanent magnets have opposite magnetic polarity arranged alternatively.

11. The magnetic induction device of claim 10, wherein each of the permanent magnets is a columnar with equilateral triangular cross section and the permanent magnets are arranged to have their individual vertical bisector aligned with a set of radial axes of the rotor base with equal radical angle distribution.

12. The magnetic induction device of claim 11, wherein the permanent magnets with a first type of the magnetic polarity are configured to face toward the center of the rotor base while the base of the permanent magnets with a second type of the magnetic polarity are configured to face toward the outer edge of the rotor base.

13. The magnetic induction device of claim 12, wherein the first type of the magnetic polarity is N pole.

14. The magnetic induction device of claim 12, wherein the second type of the magnetic polarity is S pole.

15. The magnetic induction device of claim 1, wherein each of the permanent magnets is a NdFeB permanent magnet.

16. The magnetic induction device of claim 15, wherein said permanent magnet can produce a magnetic field of 3000-7000 Gauss, preferably, 5000 Gauss.

17. The magnetic induction device of claim 1, wherein number of windings of each coil is 100-140 turns, preferably, 120 turns.

18. The magnetic induction device of claim 1, wherein the number of the coils is ranged from 12-72, preferably, 18-36.
